(19) United States
(12) Patent Application Publication
(10) Pub. No.: US 2006/0000764 A1
(43) Pub. Date: Jan. 5, 2006

(54) Pressurized screen for screening a fibrous suspension

(75) Inventors: Hans Friedrich, Heidenheim (DE); Reimund Rienecker, Heidenheim (DE); Stefan Rippl, Ravensburg (DE)

Correspondence Address: GREENBLUM & BERNSTEIN, P.L.C., 1950 ROLAND CLARKE PLACE, RESTON, VA, 20191, US

(73) Assignee: VOITH PAPER PATENT GmbH, Heidenheim (DE)

(21) Appl. No.: 11/168,300

(22) Filed: Jun. 29, 2005

(30) Foreign Application Priority Data
Jun. 30, 2004 (DE) 10 2004 031 622.8

(51) Int. Cl. B01D 29/64

(52) U.S. Cl. 210/414; 210/415

(57) ABSTRACT

Pressurized screen for screening fibrous suspension including housing, and wire basket, having wire openings, inserted in housing to surround wire chamber. Intake chamber is arranged to receive fibrous suspension through intake, accepted-stock chamber, coupled to accepted-stock outlet, is located radially outside of wire basket, and reject outlet is structured and arranged to discharge a portion of suspension rejected at wire basket. Wire scraper, located in wire chamber, has rotor body with scraper elements coupled thereto and drive arranged to run through intake chamber. Rotor body has front surface arranged to face drive, and front surface has rotationally symmetrical projection concentric to rotor body that extends into radially inner end of intake chamber having defined axial extension. Smallest diameter of projection is a maximum of 60% of largest diameter of projection.

### CROSS-REFERENCE TO RELATED APPLICATIONS

The present application claims priority under 35 U.S.C. §119 of German Patent Application No. 10 2004 031 622.8, filed on Jun. 30, 2004, the disclosure of which is expressly incorporated by reference herein in its entirety.

### BACKGROUND OF THE INVENTION

1. Field of the Invention

The present invention relates to a pressurized screen for screening a fibrous suspension with at least one wire basket inserted in a housing and surrounding a wire chamber. The wire basket is provided with a plurality of wire openings, through which a part of the fibrous suspension, which is guided through an intake into an intake chamber, then into the wire chamber, and can reach an accepted-stock outlet of an accepted-stock chamber located radially outwardly of the wire chamber. Another part of the fibrous suspension is rejected at the wire openings and discharged separately from the pressurized screen as reject through at least one reject outlet. A wire scraper, located in the wire chamber, features a preferably cylindrical rotor body having scraper elements located on the circumference of the rotor body, and a drive runs through the intake chamber.

2. Discussion of Background Information

Pressurized screens of this type are used in the preparation of paper fiber stock suspensions to process the fibrous suspension in a wet screening. To this end, such a pressurized screen contains at least one wire basket that is provided with a plurality of openings. The fibers contained in the suspension are to pass through the openings, whereas the undesirable solid components are rejected there and guided out of the screen again. Thereby, a centrifugal operation mode is used in which the suspension passes through the wire openings radially from the inside outwards. Round holes or slots generally serve as screening openings. Pressurized screens of the type under consideration here are equipped with wire scrapers that feature scraper elements which can be moved closely past the wire basket. Thus the clogging of the wire openings is prevented in a manner known per se.

The wire scraper is embodied as a rotor that is generally supported concentrically to the wire basket. The bearing housing of the wire scraper must be sealed against the paper fiber stock suspension. Thereby, the sealing device required hereto is loaded in particular by the contaminants entrained in the paper fiber stock suspension. In particular heavy particles, such as, e.g., wire pieces, broken glass, sand and stones can penetrate to the seal and damage it. Also chains of paper clips and tangled foils or strings can cause problems at the seal. In order to keep this load to a minimum, the rotor with pressurized screens of the type under consideration here is driven from the intake side, so that the sealing device can come into contact only with the inflowing suspension that is not yet concentrated with contaminants as a result of the screening process. U.S. Pat. No. 6,679,384 B1 shows an example. The situation would be different with pressurized screens driven from the reject side, such as, e.g., according to Gerrnan Application No. DE-A-199 11 884.

The separating effect of a pressurized screen is thus attributable to the fact that at least a part of the impurities contained in the fed paper fiber stock suspension cannot pass through the wire, i.e., is separated from the paper fibers on account of the size, shape or flexibility. Also known are pressurized screens in which an additional separation takes place that targets the density of the contaminants by utilizing the different forces of the contaminants in a centrifugal field. Although a majority of the heavy particles would not fit through the wire openings typically used anyway, i.e., would be rejected there, there is still the danger of damage or wear if they come into contact with the wire.

### SUMMARY OF THE INVENTION

The present invention improves the operational safety and effect of pressurized screens.

According to the invention, a pressurized screen of the aforementioned type includes a front surface of the rotor body facing the drive featuring a rotationally symmetrical projection concentric to the rotor body, which projection extends into the intake chamber at its radially inner end with a defined axial extension and the smallest diameter of this projection amounts to a maximum of 60%, preferably a maximum of 30% of the largest diameter of the projection.

With a pressurized screen in accordance with the invention, substantially more favorable flow conditions can be produced in the intake area of the housing through the measures according to the invention. The intake chamber is essentially arranged in a ring-shaped manner around the drive shaft of the wire scraper and is supplied with the fibrous suspension to be screened through, e.g., a tangentially attached intake. As a result of the rotor rotation and, where applicable, the tangential intake, a rotational flow forms in the intake chamber. Through an exemplary embodiment according to the invention, the accumulation of air and/or light particles is prevented in the intake chamber, as these can flow off upward along the projection on account of their tendency to rise. Large heavy particles, such as, e.g., stones and wire pieces, are centrifuged radially outward as a result of the centrifugal forces and can be removed in advantageous embodiments through a special heavy-particle outlet, so that they do not come into contact with the wire.

The present invention is directed to a pressurized screen for screening a fibrous suspension including a housing, at least one wire basket, having a plurality of wire openings, inserted in the a housing to surround a wire chamber. An intake chamber is arranged to receive a fibrous suspension through an intake, an accepted-stock chamber, coupled to an accepted-stock outlet, is located radially outside of the at least one wire basket, and at least one reject outlet is structured and arranged to discharge a portion of the suspension rejected at the at least one wire basket. A wire scraper, located in the at least one wire chamber, has a rotor body with scraper elements coupled thereto and a drive arranged to run through the intake chamber. The rotor body has a front surface arranged to face the drive, and the front surface has a rotationally symmetrical projection concentric to the rotor body that extends into a radially inner end of the intake chamber having a defined axial extension. A smallest diameter of the projection is a maximum of 60% of a largest diameter of the projection.

According to a feature of the invention, the smallest diameter of the projection can be a maximum of 30% of a largest diameter of the projection.

In accordance with another feature of the present invention, the rotor body may include a cylindrical rotor body. The scraper elements can be arranged on a circumference of the rotor body.

According to still another feature of the instant invention, the axial extension can be at least 20% of the axial extension of the intake chamber.

Further, the axial extension can be at least 40% of the axial extension of the intake chamber.

According to a further feature of the invention, the projection may have a truncated cone shape, the oblique angle of which is between 15° and 45°.

Moreover, a wall of the intake chamber located opposite the at least one wire chamber can be provided with an intake chamber projection extending into the intake chamber with a defined axial extension.

In accordance with a further feature, an intake may be tangentially attached to the intake chamber.

According to a still further feature, a heavy-particle outlet can be coupled to the intake chamber. Further, a heavy-particle sluice may be attached to the heavy-particle outlet, and the heavy-particle sluice may be intermittently activatable.

The at least one wire basket can include a cylindrical wire basket arranged to separate the wire chamber from the accepted-stock chamber. The wire chamber may be located radially inside the cylindrical wire basket and the accepted-stock outlet can be located radially outside the cylindrical wire basket.

According to a feature of the invention, a center line of the wire basket can be perpendicular in the position of use.

Further, a center line of the wire basket may be vertically oriented in an operating position. The reject outlet may be arranged above the wire basket, and the accepted-stock outlet can be arranged above the intake.

The heavy-particle outlet can be attached to a lower part of the intake chamber.

According to a further feature of the invention, an air and light-particle outlet can be coupled to the wire chamber from above.

In accordance with still yet another feature of the present invention, the wire scraper may be embodied to emit pressure and suction surges towards the at least one wire basket through relative movement to a surrounding liquid.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically represents a sectional side view of a pressurized screen according to the invention;

FIG. 2 illustrates a more detailed view of the intake chamber depicted in FIG. 1;

FIG. 3 diagrammatically represents a sectional top view of the pressurized screen depicted in FIG. 1,

FIG. 4 illustrates an alternative embodiment of the invention having a changed reject management.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

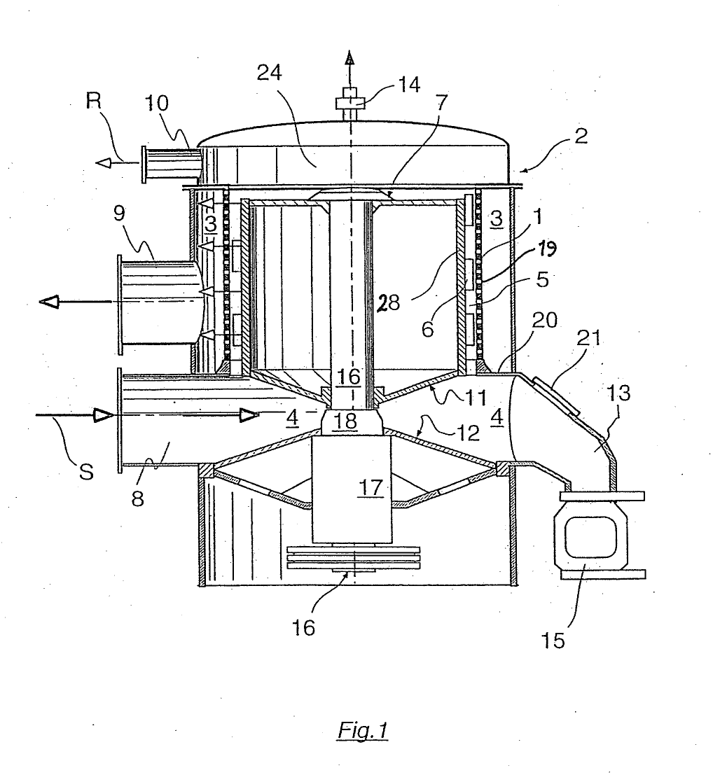

FIG. 1 shows a typical embodiment of the pressurized screen according to the invention. This pressurized screen contains in a housing 2 a cylindrical wire basket 1, the center line of which is perpendicular (vertical) in the position of use of the device. This is then also referred to as a vertical screen. The fibrous suspension S to be screened is guided into housing 2 through an intake 8. The suspension first reaches the intake chamber 4, which extends in an essentially ring-shaped manner around drive shaft 16 of wire scraper 7, and then wire chamber 5 located above it. As FIG. 3 shows, intake 8 is attached to intake chamber 4 in a tangential manner here, which reinforces the rotational flow in intake chamber 4 during the operation of the machine. The accepted stock that, coming from wire chamber 5, has passed through wire openings 19 of wire basket 1, reaches accepted-stock chamber 3 and is discharged from there through accepted-stock outlet 9. Accepted-stock outlet 9 is arranged above intake 8, so that the main flow runs from the bottom upward. Between accepted-stock chamber 3 and intake chamber 4 there is a dividing wall 20.

In wire chamber 5 there is wire scraper 7 with a rotor body 28 that is provided with a number of scraper elements 6. Through relative movement to the liquid surrounding them they produce pressure and suction surges, with which the wire openings are kept clear. In the lower part of housing 2, wire scraper 7 is in an overhung position (bearing unit 17) and is driven for rotation. The larger heavy particles collect in the lower part of intake chamber 4 and are discharged here via heavy-particle outlet 13 into heavy-particle sluice 15. The heavy-particle outlet is provided with an easily detachable lid 21 or a cleaning flap to allow for cleaning, if necessary. Hardly any fiber losses occur on account of the use of a heavy-particle sluice 15. The largest part of the suspension rejected at wire basket 1, in particular the contaminants, are collected in reject chamber 24, located above wire basket 1, and are removed as reject R from housing 2 via reject outlet 10. Reject R is generally fine-screened in order to prevent fiber losses.

In its topmost part, wire chamber 5 features a ventilation opening 14 through which air and light particles can be removed, which have flowed past wire basket 1 without having passed through wire openings 19.

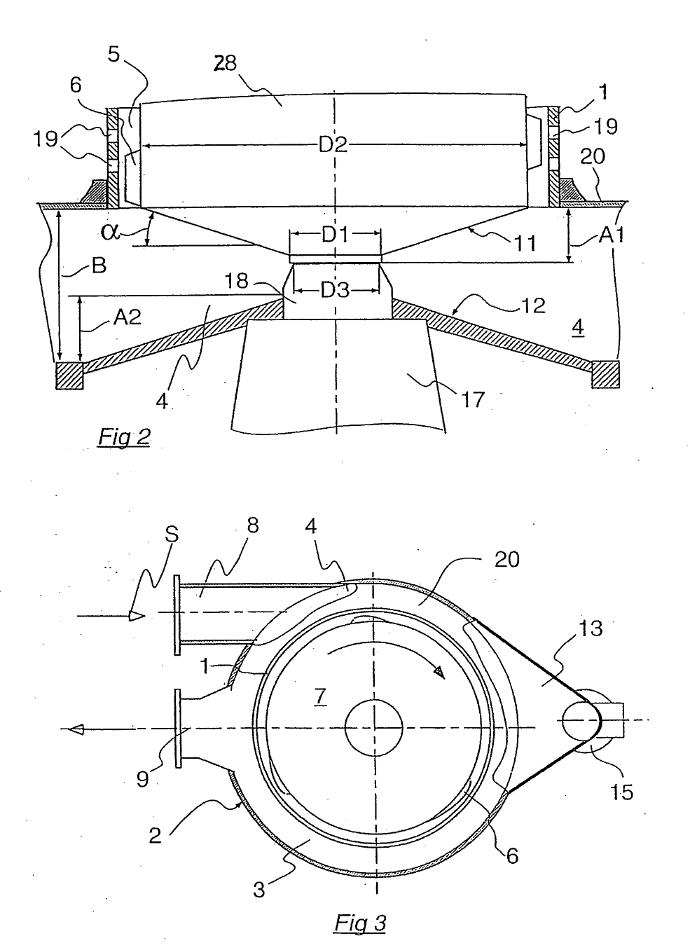

The features with which the pressurized screen is equipped according to the invention can be discerned in somewhat more detail in FIG. 2. Rotor body 28 is displayed only in its lower part and it can be seen that the front surface (here the one located below) facing the drive is provided with a truncated conical projection 11 that extends into intake chamber 4 with its pointed end. Projection 11 is dimensioned such that its smallest diameter D1 amounts to approximately 30% of the value of largest diameter D2. It is advantageous to keep the smallest diameter of projection 11 small, so that the inclined surface extends as far as possible into the central area, which improves the discharge of light particles. The oblique angle α thus forming is advantageously larger than 15°. The axial extension A1 of projection 11 can amount to at least 20% of axial extension B of the intake chamber 4. Also the wall of intake chamber 4 located opposite wire chamber 5 is provided with a projection 12, which extends into intake chamber 4 with a defined axial extension A2. The interaction of these two projections 11 and 12 causes a central narrowing of the flow cross-section in intake area 4, which leads to a considerable improvement of the discharge of light materials and air as well as of heavy particles. In the example displayed here, this narrowing continues up to the sealing unit 18 with smallest outer diameter D3. Because of its low space requirement, the sealing unit 18 can be accommodated in intake chamber 4. Thereby, a tangential arrangement of intake 8 has the advantage that the pulse of the intake flow is not directed at sealing unit 18. On account of the immediately active centrifugal forces in intake chamber 4, heavy particles, such as, e.g., wire pieces, are furthermore prevented from entering the central area where sealing unit 18 is located. By contrast, bearing unit 17 is located largely or (as here) completely outside intake chamber 4, which in particular has the advantage that intake chamber 4 can be optimized in terms of flow technology.

FIG. 3 shows a top view of the pressurized screen according to the invention with a tangential intake 8 and a radial accepted-stock outlet 9. Dividing wall 20 between accepted-stock chamber 3 and intake chamber 4 is drawn open in two places. On the right side of this representation heavy-particle outlet 13 is discernible, which is attached to housing 2 outside in the form of a lateral pocket, whereby the tangential centrifuging out of the heavy particles is promoted through appropriate shaping.

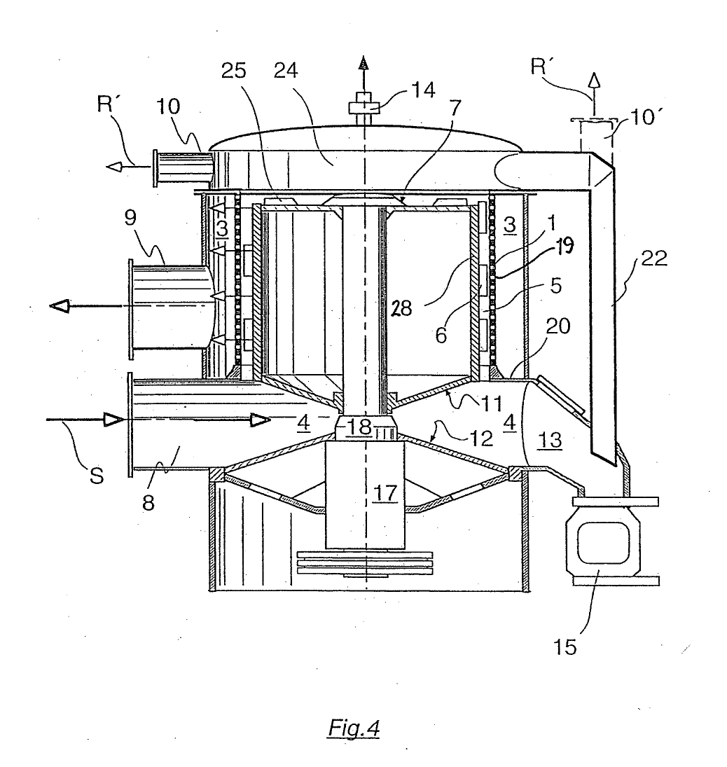

As FIG. 4 shows, a reject line 22 may open into the laterally attached heavy-particle outlet, which line is connected outside to reject chamber 24. The reject concentrated with heavy particles is thus discharged into heavy-particle outlet 13. If necessary, the pressure in reject chamber 24 can be increased by scoops 25 mounted on wire scraper 7. The remaining part R′ of the reject can be discharged through a laterally attached reject outlet 10 or via a reject outlet 10′ (drawn in dashed line) leading upward above reject line 22.

As already mentioned, the typical case of use of this device is the prescreening or course screening of newly dissolved paper stock. Wire openings 19 of the wire basket are then mostly round and have a diameter of between one and three millimeters.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A pressurized screen for screening a fibrous suspension, comprising:
a housing:
at least one Wire basket, having a plurality of wire openings, inserted in said housing to surround a wire chamber;
an intake chamber arranged to receive a fibrous suspension through an intake;
an accepted-stock chamber, coupled to an accepted-stock outlet, located radially outside of said at least one wire basket;
at least one reject outlet structured and arranged to discharge a portion of the suspension rejected at said at least one wire basket;
a wire scraper, located in said at least one wire chamber, having a rotor body with scraper elements coupled thereto and a drive arranged to run through said intake chamber;
said rotor body having a front surface arranged to face said drive, said front surface having a rotationally symmetrical projection concentric to said rotor body that extends into a radially inner end of said intake chamber having a defined axial extension,
wherein a smallest diameter of said projection is a maximum of 60% of a largest diameter of said projection.

2. The pressurized screen in accordance with claim 1, wherein said smallest diameter of said projection is a maximum of 30% of a largest diameter of said projection.

3. The pressurized screen in accordance with claim 1, wherein said rotor body comprises a cylindrical rotor body.

4. The pressurized screen in accordance with claim 3, wherein said scraper elements are arranged on a circumference of said rotor body.

5. The pressurized screen in accordance with claim 1, wherein said axial extension is at least 20% of the axial extension of said intake chamber.

6. The pressurized screen in accordance with claim 1, wherein said axial extension is at least 40% of the axial extension of the intake chamber.

7. The pressurized screen in accordance with claim 1, wherein said projection has a truncated cone shape, the oblique angle of which is between 15° and 45°.

8. The pressurized screen in accordance with claim 1, wherein a wall of said intake chamber located opposite said at least one wire chamber is provided with an intake chamber projection extending into said intake chamber with a defined axial extension.

9. The pressurized screen in accordance with claim 1, further comprising an intake tangentially attached to said intake chamber.

10. The pressurized screen in accordance with claim 1, further comprising a heavy-particle outlet coupled to said intake chamber.

11. The pressurized screen in accordance with claim 10, further comprising a heavy-particle sluice attached to said heavy-particle outlet, said heavy-particle sluice being intermittently activatable.

12. The pressurized screen in accordance with claim 1, wherein said at least one wire basket comprises a cylindrical wire basket arranged to separate said wire chamber from the accepted-stock chamber.

13. The pressurized screen in accordance with claim 12, wherein said wire chamber is located radially inside said cylindrical wire basket and said accepted-stock outlet is located radially outside said cylindrical wire basket.

14. The pressurized screen in accordance with claim 1, wherein a center line of said wire basket is perpendicular in the position of use.

15. The pressurized screen in accordance with claim 1, wherein a center line of said wire basket is vertically oriented in an operating position.

16. The pressurized screen in accordance with claim 15, wherein said reject outlet is arranged above the wire basket.

17. The pressurized screen in accordance with claim 15, wherein said accepted-stock outlet is arranged above said intake.

18. The pressurized screen in accordance with claim 10, wherein said heavy-particle outlet is attached to a lower part of said intake chamber.

19. The pressurized screen in accordance with claim 1, further comprising an air and light-particle outlet coupled to said wire chamber from above.

20. The pressurized screen in accordance with claim 1, wherein said wire scraper is embodied to emit pressure and suction surges towards said at least one wire basket through relative movement to a surrounding liquid.
